(19) United States
(12) Patent Application Publication
(10) Pub. No.: US 2023/0088077 A1
(43) Pub. Date: Mar. 23, 2023

(54) LATCH DEVICE

(71) Applicant: MITSUI KINZOKU ACT CORPORATION, Yokohama-shi, Kanagawa (JP)

(72) Inventors: Yoshiaki YOKOTA, Yokohama-shi, Kanagawa (JP); Kohei YAMASHITA, Yokohama-shi, Kanagawa (JP)

(73) Assignee: MITSUI KINZOKU ACT CORPORATION, Yokohama-shi, Kanagawa (JP)

(21) Appl. No.: 17/911,003

(22) PCT Filed: Jul. 29, 2020
(86) PCT No.: PCT/JP2020/029044

§ 371 Date: Sep. 12, 2022

(51) Int. Cl. B62D 33/037; E05B 77/34

(52) U.S. Cl. CPC B62D 33/037; E05B 77/34

(57) ABSTRACT

In a latch device for holding a tail gate in a closed state by being brought into engagement with a striker provided on a side wall of a loading space, a main shaft, which supports a claw and a ratchet, is supported in a base plate at a right end portion and is supported in a right side portion of a housing at an intermediate portion, which is positioned between the claw and the ratchet, and a pawl shaft, which supports a pawl, is supported in the right side portion of the housing at a right end portion. A first seal member is provided between the main shaft and the right side portion of the housing, and a second seal member is provided between the pawl shaft and the right side portion of the housing.

### TECHNICAL FIELD

The present invention relates to a latch device for holding an opening/closing member of a vehicle in a closed state.

### BACKGROUND ART

For example, a tail gate of a pick-up truck is known as an opening/closing member of a vehicle. In recent years, a tail gate becomes larger in size in association with an increase in size of a pick-up truck, and there have been developed technologies for opening and closing a tail gate using an electric motor (for example, refer to Patent Literature 1).

### CITATION LIST

### Patent Literature

Patent Literature 1: Description of U.S. patent Ser. No. 10/472,869

### SUMMARY OF INVENTION

### Technical Problem

When electric latch devices like the one described above are introduced, electric equipment such as an electric motor or the like needs to be protected from rain water or the like. In the latch device described in Patent Literature 1, however, no waterproof structure is described, and hence there still remains room for improvement in the waterproof performance of the latch device.

The present invention provides a latch device having a superior waterproof performance.

### Solution to Problem

According to the present invention, a latch device for holding an opening/closing member in a closed state by being brought into engagement with a striker provided on a vehicle body, including:

a claw configured to be brought into engagement with the striker to rotate;

a ratchet configured to rotate together with the claw and to hold the opening/closing member in a half open state and the closed state by being engaged with a pawl;

a first shaft configured to support the claw and the ratchet;

a second shaft configured to support the pawl;

a motor;

a driving force transmission mechanism configured to switch the opening/closing member between the half open state and the closed state using a driving force of the motor;

a housing configured to accommodate the pawl, the ratchet, the motor, and the driving force transmission mechanism; and

a base plate configured to accommodate the claw between one side portion of the housing and itself,

wherein the first shaft is supported in the base plate at one end portion and is supported in the one side portion of the housing at an intermediate portion positioned between the claw and the ratchet,

wherein the second shaft is supported in the one side portion of the housing at one end portion,

wherein a first seal member is provided between the first shaft and the one side portion of the housing, and

wherein a second seal member is provided between the second shaft and the one side portion of the housing.

### Advantageous Effects of Invention

According to the present invention, water can be prevented from intruding into the interior of the housing, whereby the waterproof performance of the latch device is improved.

### BRIEF DESCRIPTION OF DRAWINGS

FIG. 1 is a rear view of a pick-up truck that installs a latch device according to an embodiment of the present invention.

FIG. 2 is a perspective view of an interior of a tail gate of the pick-up truck shown in FIG. 1.

FIG. 3 is a perspective view of the latch device according to the embodiment of the present invention.

FIG. 4 is an exploded perspective view of the latch device shown in FIG. 3.

FIG. 5 is a right side view of the latch device shown in FIG. 3.

FIG. 6 is a sectional view taken along a line A-A in FIG. 5.

FIG. 7 is a partial enlarged view of FIG. 6.

FIG. 8 is a perspective view showing internal constituent elements of the latch device shown in FIG. 3.

FIG. 9 is a view of the latch device shown in FIG. 6 as viewed from a direction B-B therein, showing the internal constituent elements of the latch device.

FIG. 10 shows explanatory diagrams explaining a cinching operation of the latch device, in which (a) shows that the latch device stays in an unlatching position, (b) shows that the latch device stays in a half-latching position, (c) shows that the latch device stays in a cinching operation starting position, and (d) shows that the latch device stays in a full-latching position.

FIG. 11 shows explanatory diagrams explaining a release operation of the latch device, in which (a) shows that the latch device stays in a full-latching position, (b) shows the latch device stays in a release operation starting position, and (c) shows that the latch device stays in an unlatching position.

FIG. 12 shows explanatory diagrams explaining an override operation of the latch device, in which (a) shows that the latch device stays in an override operation starting position, (b) shows that the latch device stays in a state in which an override operation is being performed, and (c) shows that the latch device stays in an unlatching position.

FIG. 13 is an explanatory diagram showing a relationship between states of three switches and positions of a pawl and a ratchet.

### DESCRIPTION OF EMBODIMENTS

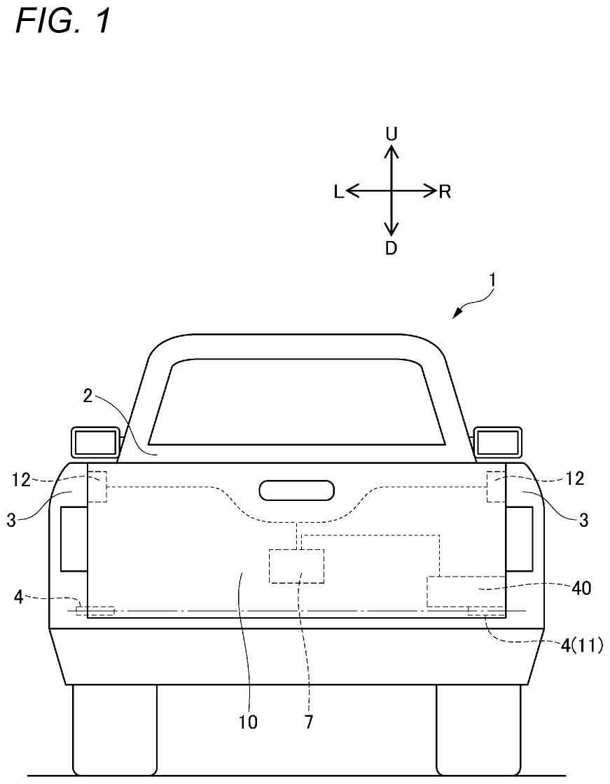

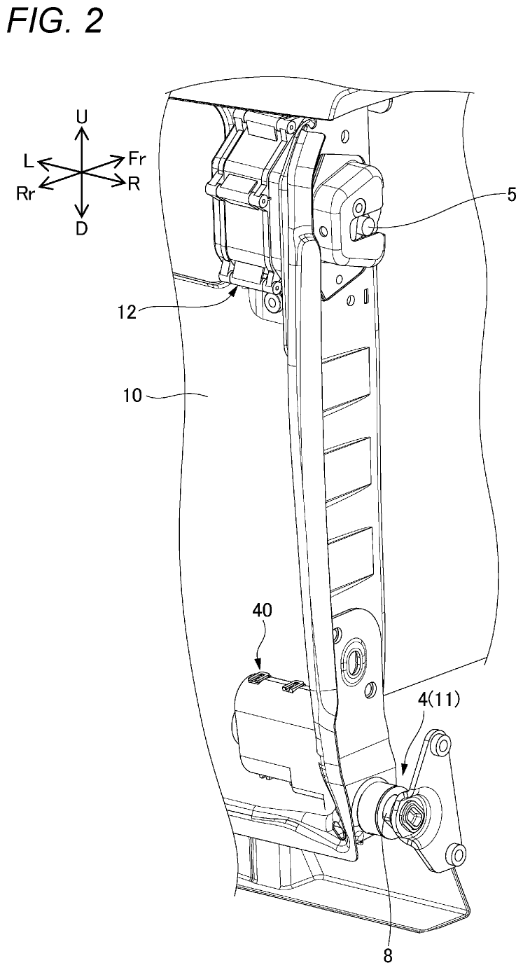

Hereinafter, a latch device according to an embodiment of the present invention will be described. First of all, a pick-up truck tail gate opening and closing mechanism, which installs the latch device according to the embodiment of the present invention, will be described based on FIGS. 1 and 2. In the drawings, Fr denotes the front of a pick-up truck, Rr denotes the rear of the pick-up truck, L denotes a left-hand side of the pick-up truck, R denotes a right-hand side of the pick-up truck, U denotes an up side of the pick-up truck, and D denotes a down side of the pick-up truck.

As shown in FIGS. 1 and 2, a loading space of a pick-up truck 1 is surrounded by a passenger compartment rear wall 2, which defines and forms a passenger compartment, and a pair of side walls 3, which face each other in a vehicle's width direction, at the front, left, and right of the loading space, respectively, and the rear of the loading space is selectively closed by the tail gate 10. FIG. 2 shows an interior of the tail gate 10 with a rear plate of the tail gate 10 removed.

The tail gate 10 is supported rotatably on the pair of side walls 3 by hinge portions 4, which are positioned at lower sides of rear end portions of the pair of side walls 3. In the present embodiment, a hinge portion 4 positioned on the right configures a hinge device 11 installed in an electric driving device 40, and this hinge device 11 can operate from a full open position to a half open position of the tail gate 10 by virtue of a driving force of the electric driving device 40 and can also operate from the half open position to the full open position of the tail gate 10 by virtue of the driving force of the electric driving device 40.

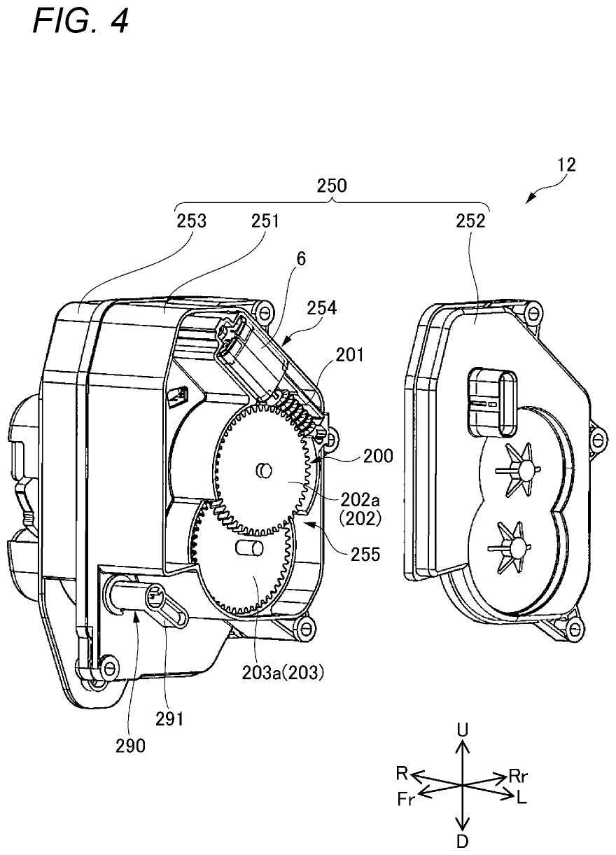

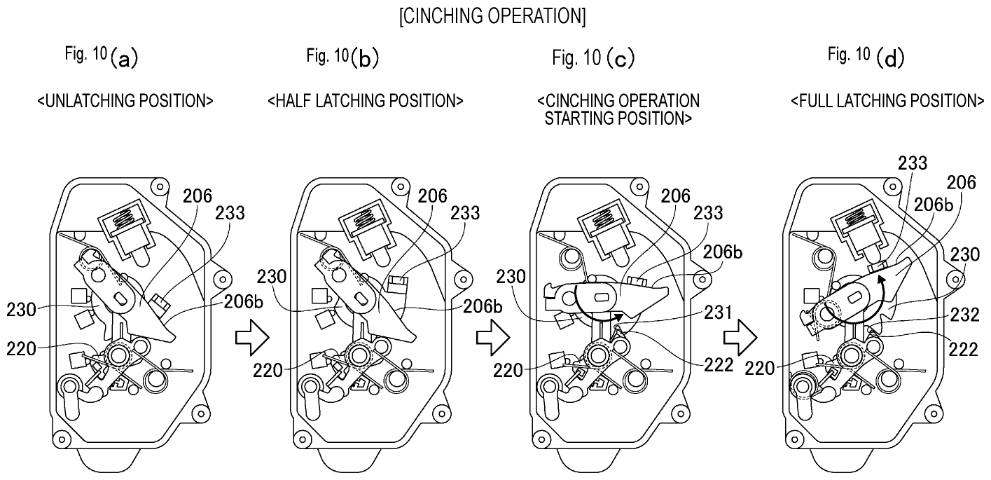

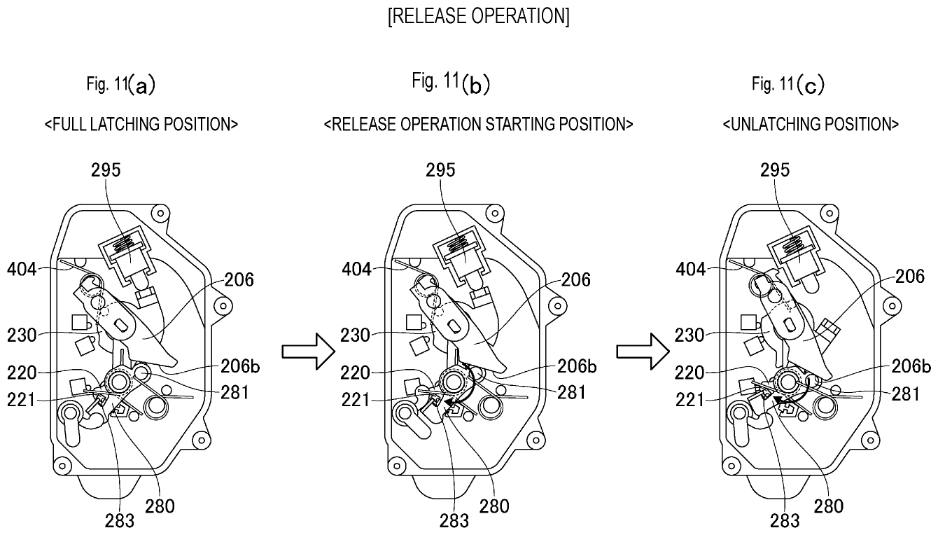

Latch devices 12, which are positioned at upper sides of the rear end portions of the pair of side walls 3, are brought into engagement with corresponding strikers 5 fixed to the side walls 3, whereby the tail gate 10 is held in a closed state on the pair of side walls 3. A motor 6 (refer to FIG. 4) is installed in each latch device 12, and then, the latch device 12 can operate from the half open position (a half latching position of the latch device 12: refer to (c) in FIG. 10) to a full close position of the tail gate 10 by virtue of a driving force of the motor 6 and can also operate from the full close position to the half open position (an unlatching position of the latch device 12: refer to (c) in FIG. 11) of the tail gate 10 by virtue of the driving force of the motor 6.

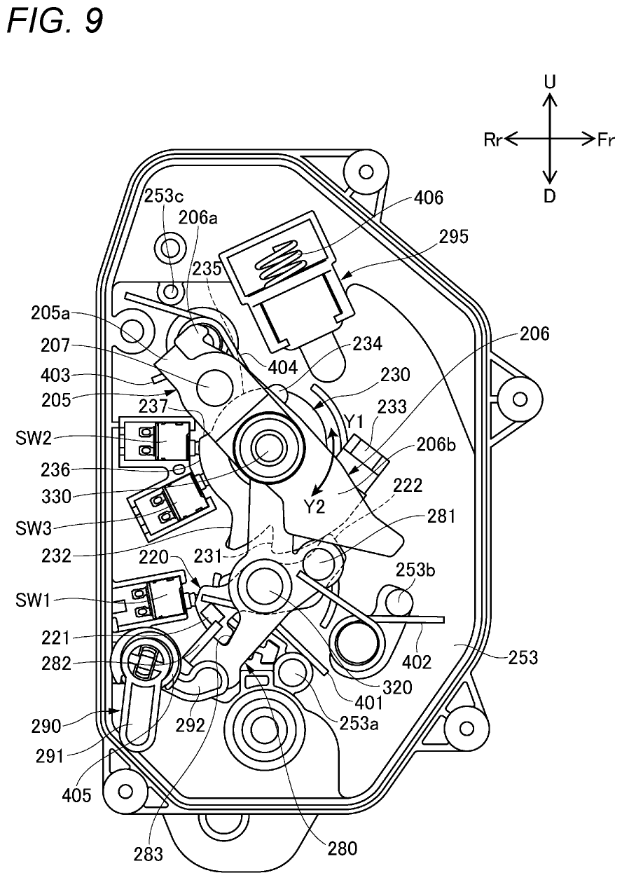

In FIG. 1, reference numeral 7 denotes a control unit (ECU) for controlling the electric driving device 40 and the motors 6 of the pair of latch devices 12. The control unit 7 includes a signal processing circuit, CPU (an arithmetic processing unit), a memory circuit, and the like and is configured to obtain positional information on the position of the tail gate 10 from three switches SW1 to SW3 (refer to FIG. 9) of the latch device 12, which will be described later, to thereby control the electric driving device 40 of the hinge device 11 and the motor 6 of each latch device 12 based on the positional information so obtained. The control unit 7 can electrically open or close the tail gate 10 in accordance with an intension of a user which is expressed through a button operation, a panel operation, or the like.

<Latch Device>

Hereinafter, although the latch device 12 will be described below, since the left and right latch devices 12 have the same configuration, in the following description, of the pair of latch devices 12, only the latch device 12 provided at the right of the tail gate 10 will be described.

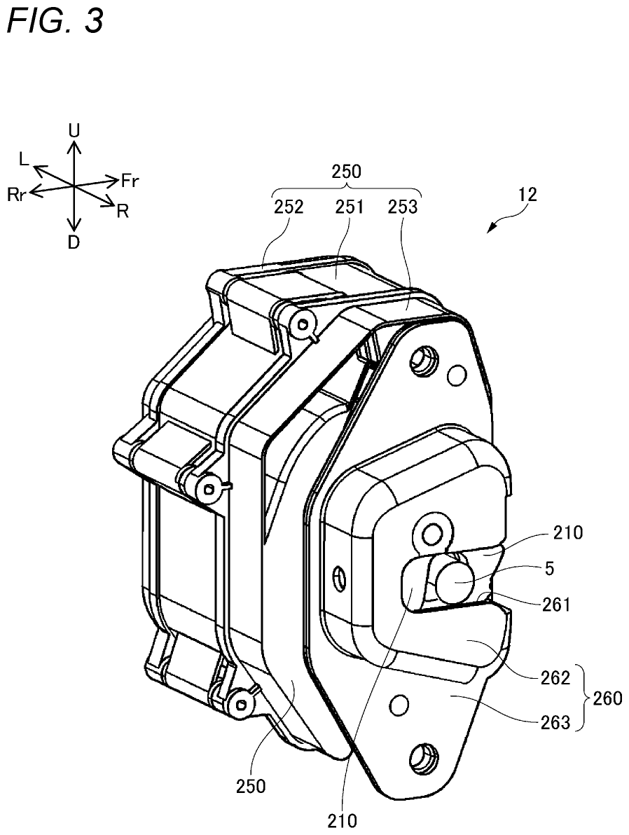

As shown in FIGS. 3 to 9, the latch device 12 includes a claw 210 configured to be brought into engagement with the striker 5, a ratchet 230 configured to rotate together with the claw 210 and hold the tail gate 10 in the half open state and the closed state as a result of a pawl 220 being brought into engagement with the ratchet 230, the motor 6, a driving force transmission mechanism 200 configured to switch the state of the tail gate 10 between the half open state and the closed state by virtue of the driving force of the motor 6, a housing 250 configured to house or accommodate the pawl 220, the ratchet 230, and the driving force transmission mechanism 200, a base plate 260 configured to accommodate the claw 210, and a back plate 270 interposed between a right side portion 250a of the housing 250 and the base plate 260.

As shown in FIGS. 3, 5 and 6, the base plate 260 includes a bottomed cylindrical base plate main body 262 in which a striker receiving groove 261 for receiving the striker 5 is formed in a bottom surface and a base plate flange portion 263 that extends in an up-down direction from the base plate main body 262. The back plate 270 is provided at a side (a left side) of the base plate main body 262 which lies opposite to a side where the striker receiving groove 261 is formed to thereby define a space for accommodating the claw 210. The base plate 260 and the back plate 270 are fixed to the right side portion 250a of the housing 250, whereby the back plate 270 is interposed between the right side portion 250a of the housing 250 and the base plate 260.

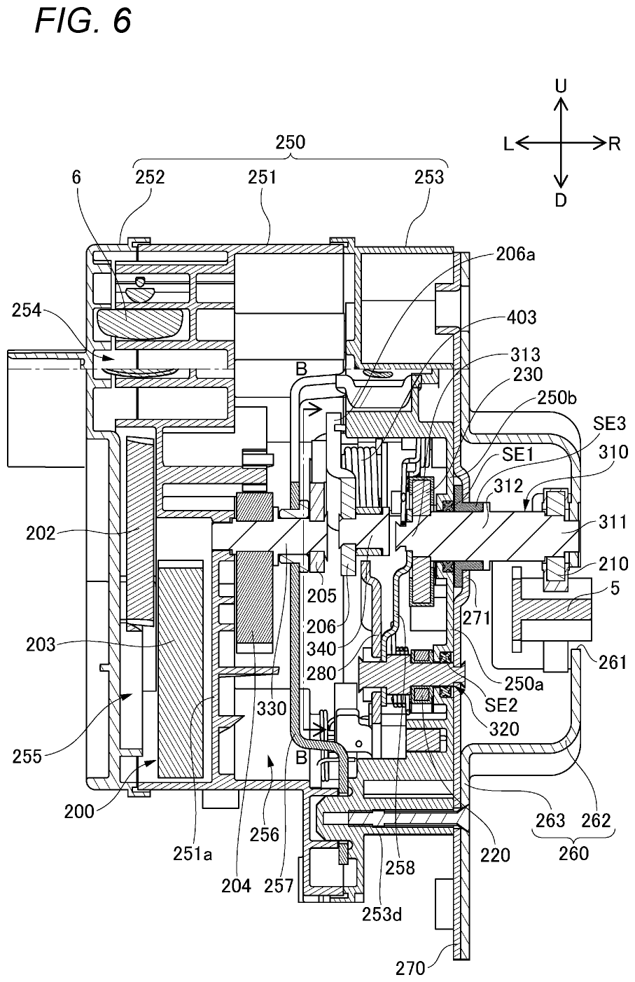

As shown in FIG. 6, the housing 250 includes a case 251 having a bulkhead portion 251a that divides an interior of the case 251 in a left-right direction, a cover 252 that is connected to a left side of the case 251, and a body 253 that is connected to a right side of the case 251. As shown in FIGS. 4 and 6, the cover 252 defines a motor accommodation portion 254 for accommodating the motor 6 and a first accommodation space 255 for accommodating a part of the driving force transmission mechanism 200 between the bulkhead portion 251a of the case 251 and itself. The body 253 defines a second accommodation space 256 for accommodating the pawl 220, the ratchet 230, and the remaining elements of the driving force transmission mechanism 200 between the bulkhead portion 251a of the case 251 and itself.

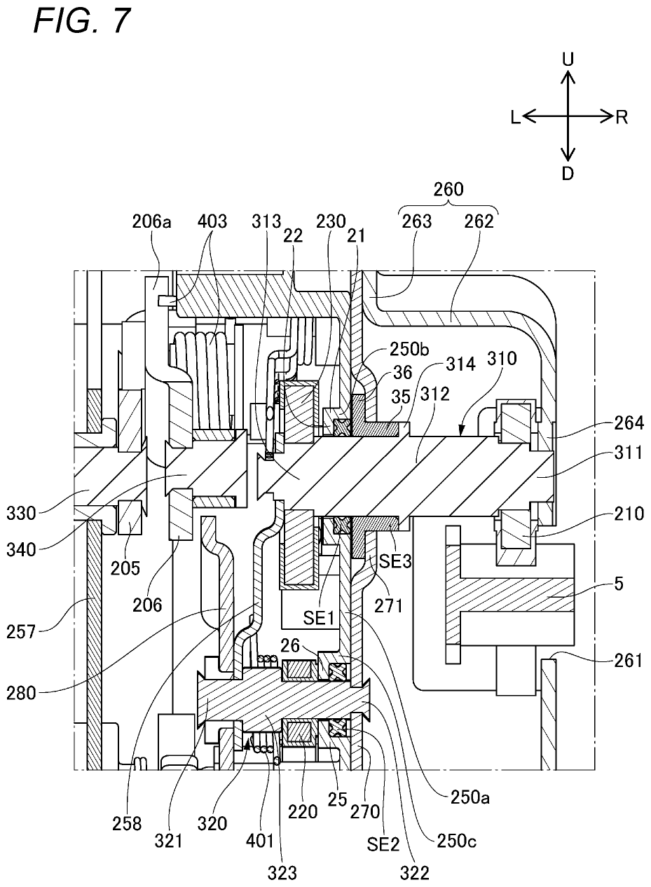

A right side portion of the body 253 configures the right side portion 250a of the housing 250 to which the back plate 270 is attached. As shown in FIGS. 6 and 7, the claw 210 is fixed to a main shaft 310 in such a manner as to be positioned in a space defined between the base plate main body 262 and the back plate 270. The ratchet 230 is fixed to the main shaft 310 in such a manner as to be positioned in the second accommodation space 256. That is, the claw 210 and the ratchet 230 are supported on the main shaft 310 in such a manner as to rotate together with the main shaft 310.

The main shaft 310 is supported by a shaft support portion 264 formed on the base plate main body 262 of the base plate 260 at a right end portion 311 and is supported by a first shaft support portion 250b formed in the right side portion 250a (the right side portion of the body 253) of the housing 250 at an intermediate portion 312, which is positioned between the claw 210 and the ratchet 230. A first support plate 258 for supporting a pawl shaft 320 is attached to a left end portion 313 of the main shaft 310, which supports the ratchet 230, in such a manner as to rotate relatively. An interior of the housing 250, in which the ratchet 230 and the like are disposed, is sealed up from the space defined between the base plate 260 and the back plate 270. This waterproofing structure will be described later.

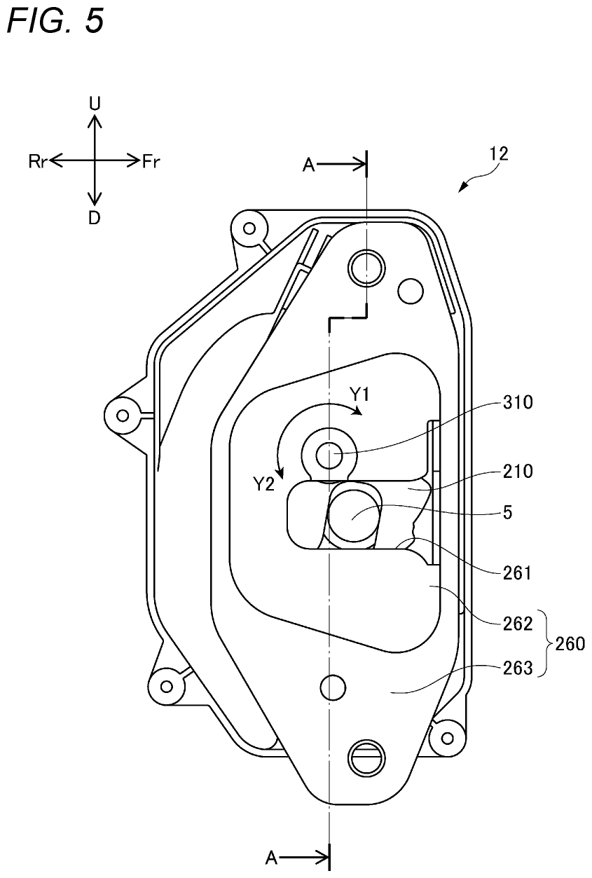

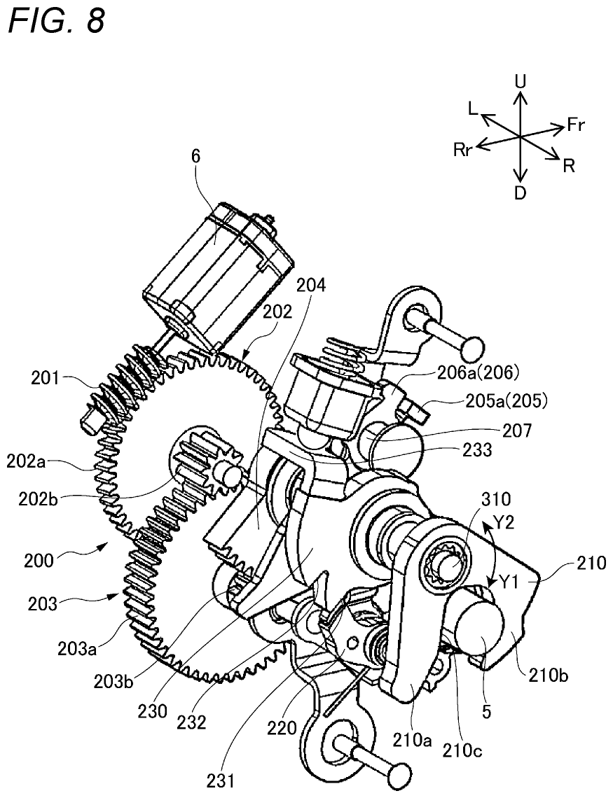

The claw 210 can rotate together with the ratchet 230 around the striker 5 in both directions, that is, in a meshing direction (a direction indicated by an arrow Y1 in FIGS. 5 and 8) and a meshing releasing direction (a direction indicated by an arrow Y2 in FIGS. 5 and 8). The claw 210 and the ratchet 230 are set in a plurality of positions including an unlatching position, a full latching position, and a half latching position lying between the unlatching position and the full latching position. As shown in FIG. 8, the claw 210 includes a first locking claw 210a and a second locking claw 210b, which extend generally in parallel, and an area where these locking claws 210a, 210b face each other is configured as a striker receiving portion 210c for receiving the striker 5.

When the striker 5 enters the striker receiving groove 261 of the base plate 260 at the time of closing the tail gate 10, the striker 5 enters the striker receiving portion 210c while pressing a facing surface of the first locking claw 210a of the claw 210 which lies on a side thereof which faces the striker receiving portion 210c. As a result, when the tail gate 10 is closed, the claw 210 is brought into meshing engagement with the striker 5 from the unlatching position and rotates about the main shaft 310 in the meshing direction (the direction indicated by the arrow Y1 in FIG. 8).

When the claw 210 rotates in the meshing direction, the ratchet 230 also rotates in the meshing direction together with the claw 210.

As shown in FIGS. 6 and 7, the pawl 220 is supported relatively rotatably on the pawl shaft 320 supported on the base plate 260. The pawl shaft 320 is disposed below the main shaft 310 and extends in the same direction as the direction in which the main shaft 310 extends. The pawl shaft 320 is supported by the first support plate 258 attached to the left end portion 313 of the main shaft 310 at a left end portion 321 thereof and is supported by a second shaft support portion 250c formed on the right side portion 250a (the right side portion of the body 253) of the housing 250 at a right end portion 322 thereof. The pawl 220, which is provided at an intermediate portion 323 of the pawl shaft 320, is configured to be able to rotate between an engagement position where the pawl 220 is brought into engagement with the ratchet 230 and a non-engagement position where the pawl 220 is not brought into engagement with the ratchet 230. This engagement position includes both a position where the pawl 220 is brought into engagement with the ratchet 230 in the half latching position and a position where the pawl 220 is brought into engagement with the ratchet 230 in the full latching position.

As shown in FIG. 9, the pawl 220 is biased in a counterclockwise direction towards the engagement positions (positions shown in (b) to (d) of FIG. 10) where the pawl 220 is brought into engagement with the ratchet 230 by a torsion spring 401 (an elastic coil spring). To make this happen, one spring end portion of the torsion spring 401 is locked at a first spring engagement portion 253a of the body 253, while the other spring end portion of the torsion spring 401 is locked at a pawl projecting portion 221 on the pawl 220. FIGS. 9 to 13 are views of the latch device 12 as seen from a different direction (a left side) from the direction in which the latch device 12 is seen in FIGS. 5 and 8, and hence, the meshing direction (the direction denoted by the arrow Y1) and the meshing releasing direction (the direction denoted by the arrow Y2) become opposite to those shown in FIGS. 5 and 8. In the present description, when the clockwise direction and the counterclockwise direction are referred to, they mean such directions based on the views shown in FIGS. 9 to 13.

Returning to FIGS. 6 and 7, a release lever 280 is attached to the left end portion 321 of the pawl shaft 320 in such a manner as to rotate relatively. As shown in FIG. 9, this release lever 280 is biased in the counterclockwise direction towards an initial position (a position shown in FIG. 9) by a torsion spring 402 (an elastic coil spring). To make this happen, one spring end portion of the torsion spring 402 is locked at a second spring engagement portion 253b of the body 253, while the other spring end portion of the torsion spring 402 is locked at a release lever projecting portion 281 of the release lever 280.

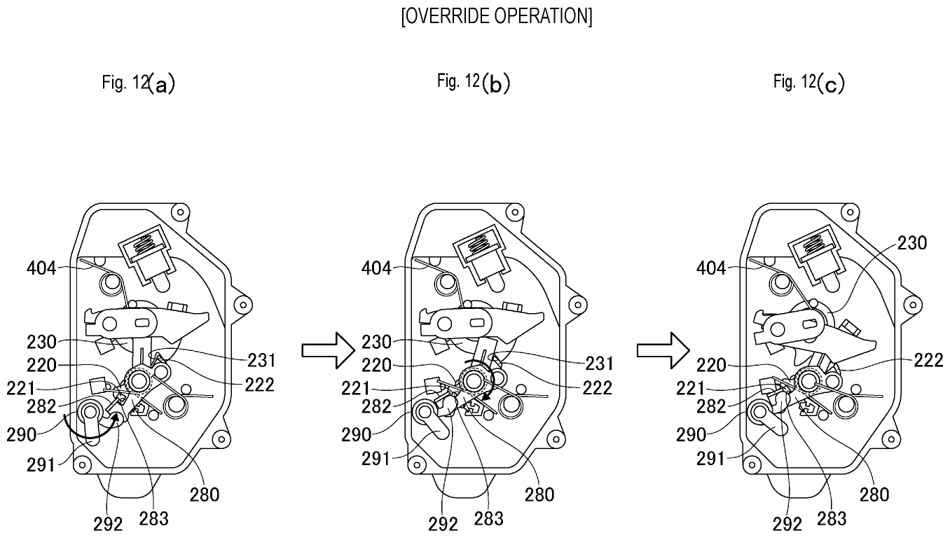

An engaged or engagement target portion 282 is provided on a side of the release lever 280 which lies opposite to a side thereof where the release lever projecting portion 281 is provided across the pawl shaft 320 in such a manner as to be pushed upwards by an engagement piece 292 of an open lever 290, which will be described later. As a result of the engagement target piece 282 of the release lever 280 being pushed upwards against a biasing force of the torsion spring 402, the release lever 280 rotates in the clockwise direction from its initial position (a position shown in FIG. 9) to a release position (a position shown in (c) of FIG. 12). As a result, the pawl projecting portion 221 is pushed up onto an upper surface of an arm 283 of the release lever 280, whereby the pawl 220 rotates from the engagement position (positions shown in (a), (b) of FIG. 12) towards the non-engagement position (a position shown in (c) in FIG. 12). When the pawl 220 stays in the engagement position, the pawl 220 is allowed to be brought into engagement with the ratchet 230 via an engagement piece 222, while when the pawl 220 stays in the non-engagement position, the engagement of the pawl 220 with the ratchet 230 is released.

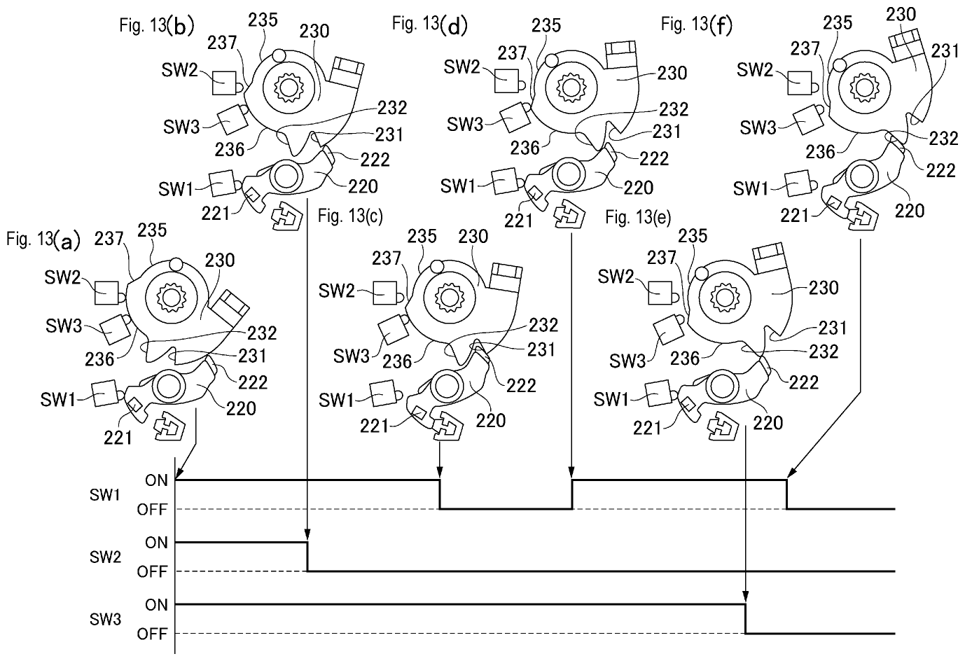

When the claw 210 rotates from the unlatching position shown in (a) of FIG. 10 about the main shaft 310 in the meshing direction to thereby be set in the full latching position shown in (d) of FIG. 10, a second locking portion 232 of the ratchet 230 is brought into engagement with the engagement piece 222 of the pawl 220, whereby the claw 210 is positioned in the full latching position to thereby be prevented from rotating about the main shaft 310 in the meshing releasing direction ((f) in FIG. 13). That is, the claw 210 is prevented from rotating in the meshing releasing direction in the full latching position. As a result, the tail gate 10 is held in the closed state.

On the other hand, when the claw 210 stays in a position just prior to the full latching position shown in (d) of FIG. 10, that is, the half latching position shown in (b) of FIG. 10, the first locking portion 231 of the ratchet 230 is brought into engagement with the engagement piece 222 of the pawl 220, whereby the claw 210 is positioned in the half latching position to thereby be prevented from rotating about the main shaft 310 in the meshing releasing direction ((c) in FIG. 13). That is, the claw 210 is prevented from rotating in the meshing releasing direction in the half latching position. As a result, the tail gate 10 is held in a so-called half open state, which occurs just prior to the closed state.

Returning to FIGS. 4, 6 and 8, the driving force transmission mechanism 200 functions to transmit the driving force of the motor 6 to the ratchet 230 for a cinching operation for rotating the claw 210 in the meshing direction from the half latching position where the claw 210 is in engagement with the striker 5 imperfectly to the full latching position where the claw 210 is in engagement with the striker 5 perfectly. This driving force transmission mechanism 200 is made up of a plurality of rotational driving members which are interposed on a driving force transmission path formed between the motor 6 and the ratchet 230 in such a manner as to be rotationally driven by the motor 6. The plurality of rotational driving members include a worm gear 201 provided on an output shaft of the motor 6, a first gear 202 having a worm wheel 202a configured to mesh with the worm gear 201 and a first pinion 202b, a second gear 203 having a spur gear 203a configured to mesh with the first pinion 202b and a second pinion 203b, a sector gear 204 configured to mesh with the second pinion 203b, an active lever 205, and a passive lever 206.

The first gear 202 and the spur gear 203a of the second gear 203 are accommodated in the first accommodation space 255 defined between the cover 252 and the bulkhead portion 251a of the case 251. The second pinion 203b of the second gear 203 and the sector gear 204 are accommodated in the second accommodation space 256 defined between the bulkhead portion 251a of the case 251 and the body 253. The power of the motor 6 is transmitted to the sector gear 204 by way of the worm gear 201, the worm wheel 202a, the first pinion 202b, the spur gear 203a, and the second pinion 203b.

The sector gear 204 is fixed to a sector gear shaft 330 which extends substantially coaxially with the main shaft 310. The sector gear shaft 330 is supported in the bulkhead portion 251a at a left end portion thereof and is supported in the second support plate 257, which is disposed between the body 253 and the case 251, in such a manner as to extend in the up-down direction at a right end portion thereof. The active lever 205 is attached to the sector gear shaft 330 on a side of the second support plate 257 which faces the body 253 (a right side thereof) in such a manner as to rotate together with the sector gear shaft 330. That is, when the sector gear 204 rotates, the active lever 205 also rotates together with the sector gear 204. The second support plate 257 is fixed at two upper and lower points with bolts which pass through the base plate flange portion 263 and the back plate 270 to thereby be fastened in place in bolt fastening portions 253d (only a lower one is shown in FIG. 6) of the body 253.

Referring to FIG. 9, too, the active lever 205 is connected to the passive lever 206, which is supported rotatably about an active lever shaft 340 disposed substantially coaxially with the sector gear shaft 330, with a connecting pin 207. In other words, the active lever 205 and the passive lever 206 are made to transmit power therebetween by way of the connecting pin 207. The connecting pin 207 is positioned above the sector gear shaft 330 and the active lever shaft 340 by a predetermined distance. A torsion spring 403 is provided on the connecting pin 207 on a side of the passive lever 206 which faces the body 253 (a right side thereof), and a relative rotation of the active lever 205 to the passive lever 206 is limited to a predetermined angle by the torsion spring 403. To make this happen, one spring end portion of the torsion spring 403 is locked on a spring engagement portion 205a at a distal end of the active lever 205, and the other spring end portion of the torsion spring 403 is locked on a spring engagement portion 206a at a distal end of the passive lever 206.

The passive lever 206 is a driven lever which is passively driven by the active lever 205, which functions as a driving lever. This passive lever 206 has an abutment arm 206b, which is configured to be brought into engagement with the engagement piece 233 of the ratchet 230 and the release lever projecting portion 281 of the release lever 280, on a side thereof which lies opposite to a side where the connecting pin 207 is provided across the active lever shaft 340. When the passive lever 206 rotates in the counterclockwise direction in a cinching operation, causing an upper surface of the abutment arm 206b to be brought into abutment with the engagement piece 233 of the ratchet 230, the ratchet 230 rotates in the counterclockwise direction. In association with this, the claw 210 meshes deeply with the striker 5 and rotates in the meshing direction. In addition, when the passive lever 206 rotates in the clockwise direction in a release operation, causing a lower surface of the abutment arm 206b to be brought into abutment with the release lever projecting portion 281 of the release lever 280, the release lever 280 rotates in the clockwise direction.

The ratchet 230 is biased so as to rotate in the clockwise direction towards its initial position (a position shown in FIG. 9) by a torsion spring 404 (an elastic coil spring). To make this happen, one spring end portion of the torsion spring 404 is locked on a third spring engagement portion 253c of the body 253, and the other spring end portion of the torsion spring 404 is locked on a ratchet projecting portion 234 of the ratchet 230.

Referring to FIG. 4, too, the open lever 290 is provided at a lower portion of the case 251 in such a manner as to lie below the first accommodation space 255 and the second accommodation space 256 with a handle 291 exposed outside. The open lever 290 is used to release manually a locked state of the tail gate 10 in which the tail gate 10 is held in the half open position or the full close position due to a failure of the motor 6 or the like, that is, a state in which the claw 210 is prevented from rotating in the meshing releasing direction. This open lever 290 is elastically biased in the clockwise direction so as to be held in its initial position (a position shown in FIG. 9) by a torsion spring 405. As shown in FIG. 9, the open lever 290 includes the engagement piece 292, which has been described above, provided in a position spaced away about 40 degrees from the handle 291 in such a manner as to extend towards the engagement target piece 282 of the release lever 280. As a result, when the handle 291 of the release lever 280 is rotated counterclockwise direction, the open lever 290 rotates in the counterclockwise direction against the biasing force of the torsion spring 405, whereby the engagement piece 292 pushes upwards the engagement target piece 282 of the release lever 280.

In addition, a popup member 295 including a compression spring 406 is provided in an upper portion of the second accommodation space 256 of the latch device 12. The popup member 295 is brought into abutment with the engagement piece 233 of the ratchet 230 when the claw 210 and the ratchet 230 are positioned in the full latching position (a position shown in (d) of FIG. 10) to thereby bias the ratchet 230 in such a manner as to rotate in the clockwise direction. Consequently, when the tail gate 10 stays in the closed state, the ratchet 230 is biased in the meshing releasing direction, that is, a direction in which the tail gate 10 is put in an open state by the torsion spring 404, which has been described above, and the popup member 295.

A first switch SW1 is provided on an outer circumferential portion of the pawl 220 in such a manner as to be brought into abutment with the pawl 220, and a second switch SW2 and a third switch SW3 are provided on an outer circumferential portion of the ratchet 230 in such a manner as to be brought into abutment with an outer circumferential surface of the ratchet 230. An outer circumferential step portion 237, configured to connect a small-diameter portion 235 with a large-diameter portion 236, is provided on the outer circumferential surface of the ratchet 230 in a position lying spaced away from the first locking portion 231 and the second locking portion 232. The switches SW1 to SW3 are switched on and off as the pawl 220 and the ratchet 230 rotate.

A relationship between the states of the switches SW1 to SW3 and the positions of the pawl 220 and the ratchet 230 will be described by reference to FIG. 13.

All the switches SW1 to SW3 are switched on in a state shown in (a) of FIG. 13 in which the ratchet 230 stays in the unlatching position, that is, a state in which the tail gate 10 is fully opened.

As shown in (b) of FIG. 13, when the tail gate 10 rotates from this state by a predetermined angle in the closing direction to thereby cause the striker 5 to be brought into engagement with the claw 210 and the ratchet 230 rotates in the counterclockwise direction as the claw 210 so rotates, the second switch SW2, which is in abutment with the large-diameter portion 236 of the ratchet 230, moves over the outer circumferential step portion 237 to thereby be switched off.

Further, when the tail gate 10 rotates further by a predetermined angle in the closing direction to thereby be put in the half open state as shown in (c) of FIG. 13, that is, the latch device 12 is positioned in the half latching position where the first locking portion 231 of the ratchet 230 is brought into engagement with the engagement piece 222 of the pawl 220, the first switch SW1, which is in abutment with the outer circumferential surface of the pawl 220, is then switched off.

When the tail gate 10 rotates further by a predetermined angle in the closing direction from the half open state as shown in (d) of FIG. 13, the pawl 220 rotates clockwise direction, whereby the first switch SW1 is switched on again.

When the tail gate 10 rotates further by a predetermined angle in the closing direction from the state shown in (d) to thereby be put in a state which would result just prior to the closed state of the tail gate 10 as shown in (e) of FIG. 13, the third switch SW3, which is in abutment with the large-diameter portion 236 of the ratchet 230, also moves over the outer circumferential step portion 237 to thereby be switched off.

When the tail gate 10 rotates further by a predetermined angle in the closing direction from the state shown in (e) to thereby be put in a closed state as shown in (f) of FIG. 13, the first switch SW1, which is in contact with the outer circumferential surface of the pawl 220, is switched off, whereby all the switches SW1 to SW3 are switched off.

Hereinafter, a cinching operation, a release operation, and an override operation of the latch device 12 configured as described heretofore will be described.

[Cinching Operation]

First of all, a cinching operation of the latch device 12 will be described by reference to FIG. 10.

As shown in (a) of FIG. 10, when the tail gate 10 stays in the full open state, the claw 210 and the ratchet 230 are positioned in the unlatching position.

When the tail gate 10 is rotated from this state by means of a driving force of the electric driving device 40 of the hinge device 11, the striker 5 is brought into engagement with the claw 210, and the ratchet 230 rotates in the counterclockwise direction as the claw 210 so rotates. Then, the engagement piece 222 of the pawl 220 is brought into engagement with the first locking portion 231 of the ratchet 230 ((c) of FIG. 13), whereby the claw 210 and the ratchet 230 are positioned in the half latching position ((b) of FIG. 10). In this state, the claw 210 is prevented from rotating in the meshing releasing direction, whereby the tail gate 10 is held in the half open state.

When the control unit 7 recognizes the half open state ((c) of FIG. 13) of the tail gate 10 from the states of the three switches SW1 to SW3, the control unit 7 causes the motor 6 of the latch device 12 to be driven in a forward rotating direction (the closing direction). The passive lever 206 is caused to rotate in the counterclockwise direction via the driving force transmission mechanism 200, which has been described before, by means of the driving force of the motor 6, and then, the abutment arm 206b of the passive lever 206 is brought into abutment with the engagement piece 233 of the ratchet 230 (a cinching operation starting position in (c) of FIG. 10).

When the motor 6 is driven further in the forward rotating direction (the closing direction), the abutment arm 206b of the passive lever 206 pushes on the engagement piece 233 of the ratchet 230, causing the ratchet 230 to rotate in the counterclockwise direction. When the engagement piece 222 of the pawl 220 is brought into engagement with the second locking portion 232 of the ratchet 230 ((f) of FIG. 13), the claw 210 and the ratchet 230 are positioned in the full latching position ((d) of FIG. 10). In this state, the claw 210 is prevented from rotating in the meshing releasing direction, whereby the tail gate 10 is held in the closed state.

[Release Operation]

Next, a release operation of the latch device 12 will be described by reference to FIG. 11.

The motor 6 is driven in a reverse or backward rotating direction (an opening direction) from the full latching position (the closed state of the tail gate 10) of the claw 210 and the ratchet 230 shown in (a) of FIG. 11. The passive lever 206 is caused to rotate in the clockwise direction via the driving force transmission mechanism 200, which has been described before, by means of the driving force of the motor 6, and then, a lower surface of the abutment arm 206b of the passive lever 206 is brought into abutment with the release lever projecting portion 281 of the release lever 280 (a release operation starting position shown in (b) of FIG. 11).

When the motor 6 is further driven in the backward rotating direction (the opening direction), the abutment arm 206b of the passive lever 206 pushes on the release lever projecting portion 281 of the release lever 280 to thereby cause the release lever 280 to rotate in the clockwise direction. When the release lever 280 rotates in the clockwise direction, the arm 283 of the release lever 280 is brought into abutment with the pawl projecting portion 221 of the pawl 220 to thereby cause the pawl 220 to rotate in the clockwise direction. When the pawl 220 rotates in the clockwise direction, the engagement piece 222 of the pawl 220 is disengaged from the second locking portion 232 of the ratchet 230. As this occurs, the ratchet 230 is pushed out in a lock releasing direction, that is, in the clockwise direction by means of the biasing forces of the torsion spring 404 and the popup member 295.

When the meshing of the engagement piece 222 of the pawl 220 with the ratchet 230 is released, the ratchet 230 is caused to rotate in the clockwise direction by the torsion spring 404, and further, when the tail gate 10 is caused to rotate in the opening direction by means of the driving force of the electric driving device 40 of the hinge device 11, the striker 5 is disengaged from the claw 210, and then, the claw 210 and the ratchet 230 are positioned in the unlatching position (an unlatching position in (c) of FIG. 11), whereby the tail gate 10 is put in a full open state.

[Override Operation]

Next, an override operation of the latch device 12 will be described by reference to FIG. 12.

An override operation is an operation intended to be executed to open the tail gate 10 manually in the event that the release operation described above cannot be executed as a result of the motor 6 being unable to be driven for some reason with the claw 210 and the ratchet 230 being prevented from rotating in the meshing releasing direction as in the full latching position (the closed state of the tail gate 10) or the half latching position (the half open state of the tail gate 10).

(a) of FIG. 12 is an explanatory diagram showing the cinching operation starting position shown in (c) of FIG. 10. In this state, the engagement piece 222 of the pawl 220 is in engagement with the first locking portion 231 of the ratchet 230, and the claw 210 and the ratchet 230 are prevented from rotating in the meshing releasing direction.

When the handle 291 of the open lever 290, which is exposed to the outside of the housing 250, is rotated in the counterclockwise direction, the engagement piece 292 rotates in the counterclockwise direction and then pushes upwards the engagement target piece 282 of the release lever 280 ((b) of FIG. 12). When the engagement target piece 282 is pushed upwards, causing the release lever 280 to rotate in the clockwise direction, the arm 283 of the release lever 280 pushes upwards the pawl projecting portion 221 of the pawl 220. Then, the pawl 220 is caused to rotate in the clockwise direction, whereby the engagement piece 222 of the pawl 220 is disengaged from the first locking portion 231 of the ratchet 230.

When the meshing of the engagement piece 222 of the pawl 220 with the ratchet 230 is released, the ratchet 230 is caused to rotate in the clockwise direction by the torsion spring 404, whereby the tail gate 10 can be opened with the rotational driving members of the driving force transmission mechanism 200 standing idle by manually pushing downwards the tail gate 10.

[Waterproof Structure]

Subsequently, a waterproof structure of the latch device 12, which is a subject matter of the present invention, will be described by reference to FIGS. 6 and 7.

In the latch device 12 of the present embodiment, the interior of the housing 250 is sealed from the space defined between the base plate 260 and the back plate 270. That is, although the main shaft 310 and the pawl shaft 320 penetrate through the right side portion 250a of the housing 250, even in the event that water intrudes from the striker receiving groove 261 into the space defined between the base plate main body 262 and the back plate 270, the water is prevented from intruding into the second accommodation space 256 of the housing 250 by the waterproof structure of the latch device 12.

To make this happen, a first seal member SE1 is provided between the main shaft 310 which supports the claw 210 and the ratchet 230 and the right side portion 250a of the housing 250 (the right side portion of the body 253), and a second seal member SE2 is provided between the pawl shaft 320 which supports the pawl 220 and the right side portion 250a of the housing 250 (the right side portion of the body 253).

The first seal member SE1 is provided in a first shaft support portion 250b formed on the right side portion 250a of the housing 250. The first shaft support portion 250b includes a body cylindrical portion 21 projecting into an annular shape in a direction moving away from the back plate 270 and a body annular portion 22 extending radially inwards from a distal end portion of the body cylindrical portion 21 in such a manner as to surround the main shaft 310 circumferentially, which are provided on the right side portion 250a which is in abutment with the back plate 270. The first seal member SE1 is accommodated in a space defined by the body cylindrical portion 21 and the body annular portion 22 and is disposed around the main shaft 310 which penetrates through the body annular portion 22. The first seal member SE1 has an X-shaped cross section and seals up a space defined between the right side portion 250a of the housing 250 and the main shaft 310.

As a result, since the first seal member SE1 is provided between the main shaft 310 which supports the claw 210 and the ratchet 230 and the right side portion 250a of the housing 250, even in the event that water intrudes into the inside of the base plate 260, the water is prevented from intruding further into the interior of the housing 250.

Additionally, a third seal member SE3 is provided in such a manner as to be disposed around the main shaft 310 so as to seal up a space between the back plate 270 and the main shaft 310. To describe this more specifically, the back plate 270 includes a protruding portion 271 which protrudes in a direction in which it moves away from the right side portion 250a of the housing 250 so as to define a space between the right side portion 250a of the housing 250 and itself. A predetermined gap is provided between a distal end portion of the protruding portion 271 and the main shaft 310.

The third seal member SE3 includes a seal cylindrical portion 35 passing through this gap to extend along the main shaft 310 and a seal flange portion 36 extending from the seal cylindrical portion 35 radially outwards towards the space defined between the right side portion 250a of the housing 250 and the protruding portion 271. The seal flange portion 36 of the third seal member SE3 is held between the right side portion 250a of the housing 250 and the protruding portion 271, and the seal cylindrical portion 35 of the third seal member SE3 is held between a flange portion 314 of the main shaft 310 which is formed on a side of the protruding portion 271 of the back plate 270 which faces the claw 210 and the first seal member SE1.

As a result, the space defined between the main shaft 310 and the back plate 270 is sealed up by the third seal member SE3. Thus, since the first seal member SE1 and the third seal member SE3 are provided between the main shaft 310 and the right side portion 250a of the housing 250 and the back plate 270, the waterproof function between the main shaft 310 and the right side portion 250a of the housing 250 can be improved further.

The second seal member SE2 is provided at the second shaft support portion 250c formed on the right side portion 250a of the housing 250. The second shaft support portion 250c includes a body cylindrical portion 25 projecting into an annular shape in a direction moving away from the back plate 270 and a body annular portion 26 extending radially inwards from a distal end portion of the body cylindrical portion 25 in such a manner as to surround the pawl shaft 320 circumferentially, which are provided on the right side portion 250a which is in abutment with the back plate 270. The second seal member SE2 is accommodated in a space defined by the body cylindrical portion 25 and the body annular portion 26 and is disposed around the pawl shaft 320 which penetrates through the body annular portion 26. The second seal member SE2 has an X-shaped cross section and seals up a space defined between the right side portion 250a of the housing 250 and the pawl shaft 320.

As a result, since the second seal member SE2 is provided between the pawl shaft 320 which supports the pawl and the right side portion 250a of the housing 250, even in the event that water intrudes into the inside of the back plate 260, the water is prevented from intruding further into the interior of the housing 250. Since the pawl shaft 320 is a fixed shaft, the waterproof structure of the pawl shaft 320 is made simpler than the waterproof structure of the main shaft 310, which is a rotational shaft.

Thus, although the main shaft 310 and the pawl shaft 320 penetrate through the right side portion 250a of the housing 250, water is prevented from intruding into the second accommodation space 256 of the housing 250 by the waterproof structure of the latch device 12. In order to strengthen the waterproof function of the housing 250, a waterproof structure may be provided individually between the case 251 and the cover 252 and between the case 251 and the body 253. The waterproof structure adopts, for example, an 0 ring having a circular or elliptic cross section or an X ring having an X-shaped cross section. As a result, providing the waterproof structure individually between the case 251 and the cover 252 and between the case 251 and the body 253 can prevent the intrusion of water into the interior of the housing 250 in a more ensured fashion.

In addition, since the latch device 12 includes the popup member 295 in addition to the torsion spring 404 which biases the ratchet 230 in a direction in which the tail gate 10 is put in an open state, the tail gate 10 provides a good response when the tail gate 10 is shifted from the closed state to the open state. In addition, since these constituent elements are disposed in the interior of the housing 250 which is sealed up, a risk of the constituent elements being exposed to water can be avoided.

Thus, although the embodiment of the present invention has been described heretofore by reference to the drawings, needless to say, the present invention is not limited to the embodiment at all. It is obvious that those skilled in the art to which the present invention pertains will arrive at various altered examples or modified examples without departing from the spirit and scope of the present invention, and it is natural to understand that those altered or modified examples will fall within the technical scope of the present invention. Additionally, the constituent elements described in the embodiment may be combined together arbitrarily without departing from the spirit and scope of the present invention.

The present description describes at least the following matters. The corresponding constituent elements described in the embodiment are parenthesized, but the present invention is not limited to those parenthesized constituent elements.

(1) A latch device (the latch device 12) for holding an opening/closing member (the tail gate 10) in a closed state by being brought into engagement with a striker (the striker 5) provided on a vehicle body (the side wall 3), including:

a claw (the claw 210) configured to be brought into engagement with the striker to rotate;

a ratchet (the ratchet 230) configured to rotate together with the claw and hold the opening/closing member in a half open state and the closed state by being engaged with a pawl (the pawl 220);

a first shaft (the main shaft 310) configured to support the claw and the ratchet;

a second shaft (the pawl shaft 320) configured to support the pawl;

a motor (the motor 6);

a driving force transmission mechanism (the driving force transmission mechanism 200) configured to switch the opening/closing member between the half open state and the closed state using a driving force of the motor;

a housing (the housing 250) configured to accommodate the pawl, the ratchet, the motor, and the driving force transmission mechanism; and

a base plate (the base plate 260) configured to accommodate the claw between one side portion (the right side portion 250a) of the housing and itself,

wherein the first shaft is supported in the base plate at one end portion (the right end portion 311) and is supported in the one side portion of the housing at an intermediate portion (the intermediate portion 312) positioned between the claw and the ratchet,

wherein the second shaft is supported in the one side portion of the housing at one end portion (the right end portion 322),

wherein a first seal member (the first seal member SE1) is provided between the first shaft and the one side portion of the housing, and

wherein a second seal member (the second seal member SE2) is provided between the second shaft and the one side portion of the housing.

According to (1), since the first seal member is provided between the first shaft, which supports the claw and the ratchet, and the one side portion of the housing, and the second seal member is provided between the second shaft, which supports the pawl, and the one side portion of the housing, even in the event that water intrudes into the inside of the base plate, the water is prevented from intruding into the interior of the housing.

(2) The latch device according to (1),

wherein the first seal member is disposed around the first shaft and is a seal member having an X-shaped cross section and sealing up a space defined between the one side portion of the housing and the first shaft.

According to (2), the waterproof function between the first shaft and the one side portion of the housing can be improved further.

(3) The latch device according to (1) or (2),

wherein a back plate (the back plate 270) is provided between the one side portion of the housing and the base plate,

wherein the intermediate portion of the first shaft is supported in the one side portion of the housing and the back plate,

wherein the first shaft includes a flange portion (the flange portion 314),

wherein the back plate includes a protruding portion (the protruding portion 271) formed around the first shaft in such a manner as to protrude in a direction moving away from the one side portion of the housing so as to define a space between the one side portion of the housing and itself,

wherein a third seal member (the third seal member SE3) is provided on the first shaft in such a manner as to be disposed around the first shaft so as to seal up a space defined between the back plate and the first shaft, and

wherein the third seal member includes:

a seal cylindrical portion (the seal cylindrical portion 35) extending between the one side portion of the housing and the flange portion along the first shaft; and

a seal flange portion (the seal flange portion 36) extending from the seal cylindrical portion towards the space.

According to (3), since the first seal member and the third seal member are provided between the first shaft and the one side portion of the housing and the back plate, respectively, the waterproof function between the first shaft and the one side portion of the housing can be improved further.

(4) The latch device according to any one of (1) to (3),

wherein the second seal member is a seal member having an X-shaped cross section which is disposed around the second shaft to seal up a space defined between the one side portion of the housing and the second shaft.

According to (4), the waterproof function between the second shaft and the one side portion of the housing can be improved further.

(5) The latch device according to any one of (1) to (4), including further:

a torsion spring (the torsion spring 404) configured to bias the ratchet in a direction in which the opening/closing member is put in an open state; and

a popup member (the popup member 295) including a compression spring (the compression spring 406) configured to be brought into abutment with the ratchet when the opening/closing member is in the closed state to bias the ratchet in the direction in which the opening/closing member is put in the open state,

wherein the torsion spring and the popup member are disposed in an interior of the housing sealed up by the first seal member and the second seal member.

According to (5), since the popup member is provided in addition to the torsion spring which biases the ratchet in the direction in which the opening/closing member is put in the open state, the opening/closing member provides a good response when the opening/closing member is shifted from the closed state to the open state. In addition, since these constituent elements are disposed in the interior of the housing which is sealed up, a risk of the constituent elements being exposed to water can be avoided.

(6) The latch device according to any one of (1) to (4),

wherein the housing includes:

a case (the case 251) having a bulkhead portion (the bulkhead portion 251a);

a cover (the cover 252) connected to one side (the left side) of the bulkhead portion of the case to define a motor accommodation portion (the motor accommodation portion 254) configured to accommodate the motor and a first accommodation space (the first accommodation space 255) configured to accommodate a part of the driving force transmission mechanism; and

a body (the body 253) connected to the other side (the right side) of the bulkhead portion of the case to define a second accommodation space (the second accommodation space 256) configured to accommodate the pawl, the ratchet, and a remaining part of the driving force transmission mechanism,

wherein the body configures the one side portion of the housing, and

wherein a waterproof structure is respectively provided between the case and the cover and between the case and the body.

According to (6), since the waterproof structure is provided individually between the case and the cover and between the case and the body, the intrusion of water into the interior of the housing can be prevented in a more ensured fashion.

### REFERENCE SIGNS LIST

3 Side wall (vehicle body)
5 Striker
6 Motor
10 Tail gate (opening/closing member)
12 Latch device
35 Seal cylindrical portion
200 Driving force transmission mechanism
210 Claw
220 Pawl
230 Ratchet
250a Right side portion (one side portion of housing)
250 Housing
251a Bulkhead portion
251 Case
252 Cover
253 Body
254 Motor accommodation portion
255 First accommodation space
256 Second accommodation space
260 Base plate
270 Back plate
271 Protruding portion
295 Popup member
310 Main shaft (first shaft)
320 Pawl shaft (second shaft)
311 Right end portion (one end portion of first shaft)
322 Right end portion (one end portion of second shaft)
312 Intermediate portion (intermediate portion of first shaft)
314 Flange portion
404 Torsion spring
406 Compression spring
SE1 First seal member
SE2 Second seal member
SE3 Third seal member

1. A latch device for holding an opening/closing member in a closed state by being brought into engagement with a striker provided on a vehicle body, comprising:
a claw configured to be brought into engagement with the striker to rotate;
a ratchet configured to rotate together with the claw and to hold the opening/closing member in a half open state and the closed state by being engaged with a pawl;
a first shaft configured to support the claw and the ratchet;
a second shaft configured to support the pawl;
a motor;
a driving force transmission mechanism configured to switch the opening/closing member between the half open state and the closed state using a driving force of the motor;
a housing configured to accommodate the pawl, the ratchet, the motor, and the driving force transmission mechanism; and
a base plate configured to accommodate the claw between a first side portion of the housing and the base plate,
wherein the first shaft is supported in the base plate at a first end portion and is supported in the first side portion of the housing at an intermediate portion positioned between the claw and the ratchet,
wherein the second shaft is supported in the first side portion of the housing at a first end portion,
wherein a first seal member is provided between the first shaft and the first side portion of the housing, and
wherein a second seal member is provided between the second shaft and the first side portion of the housing.

2. The latch device according to claim 1,
wherein the first seal member is disposed around the first shaft, the first seal member being a seal member having an X-shaped cross section and sealing up a space defined between the first side portion of the housing and the first shaft.

3. The latch device according to claim 1,
wherein a back plate is provided between the first side portion of the housing and the base plate,
wherein the intermediate portion of the first shaft is supported in the first side portion of the housing and the back plate,
wherein the first shaft comprises a flange portion,
wherein the back plate comprises a protruding portion formed around the first shaft in such a manner as to protrude in a direction moving away from the first side portion of the housing so as to define a space between the first side portion of the housing and the back plate,
wherein a third seal member is provided on the first shaft in such a manner as to be disposed around the first shaft so as to seal up a space defined between the back plate and the first shaft, and
wherein the third seal member comprises:
a seal cylindrical portion extending between the first side portion of the housing and the flange portion along the first shaft; and
a seal flange portion extending from the seal cylindrical portion towards the space.

4. The latch device according to claim 1,
wherein the second seal member is disposed around the second shaft, the second seal member being a seal member having an X-shaped cross section and sealing up a space defined between the first side portion of the housing and the second shaft.

5. The latch device according to claim 1, further comprising:
a torsion spring configured to bias the ratchet in a direction in which the opening/closing member is put in an open state; and
a popup member comprising a compression spring configured to be brought into abutment with the ratchet when the opening/closing member is in the closed state to bias the ratchet in the direction in which the opening/closing member is put in the open state,
wherein the torsion spring and the popup member are disposed in an interior of the housing sealed up by the first seal member and the second seal member.

6. The latch device according to claim 1,
wherein the housing comprises:
a case having a bulkhead portion;
a cover connected to a first side of the bulkhead portion of the case, the cover defining:
a motor accommodation portion configured to accommodate the motor; and
a first accommodation space configured to accommodate a part of the driving force transmission mechanism; and
a body connected to a second side of the bulkhead portion of the case, the second side being opposite to the first side, the body defining a second accommodation space configured to accommodate the pawl, the ratchet, and a remaining part of the driving force transmission mechanism,
wherein the body configures the first side portion of the housing, and
wherein a waterproof structure is respectively provided between the case and the cover and between the case and the body.
